(19) United States
(12) Patent Application Publication
(10) Pub. No.: US 2009/0035507 A1
(43) Pub. Date: Feb. 5, 2009

(54) Touch Fasteners With Images

(75) Inventor: Wallace L. Kurtz, JR., Lunenburg, MA (US)

Correspondence Address: FISH & RICHARDSON PC, P.O. BOX 1022, MINNEAPOLIS, MN, 55440-1022, US

(73) Assignee: VELCRO INDUSTRIES B.V., Curacao (AN)

(21) Appl. No.: 11/832,211

(22) Filed: Aug. 1, 2007

(51) Int. Cl. B28B 23/00

(52) U.S. Cl. 428/87; 264/173.1

(57) ABSTRACT

A method of making a touch fastener includes continuously introducing molten resin to a pressure zone at a peripheral surface of a rotating mold roll, such that pressure in the pressure zone forces some of the resin into an array of stem cavities defined in the mold roll to form resin stems while a remainder of the resin forms a base at the roll surface, interconnecting the stems. The method includes forming engageable heads on the stems to form fastener elements and transferring an image substance onto the peripheral surface of a nip transfer roll that transfers the image substance into the pressure zone. The image substance becomes bonded to the resin of the base in the pressure zone to form an image visible on the base.

### TECHNICAL FIELD

This disclosure relates to touch fasteners with images.

### BACKGROUND

In general, touch fasteners include two mating components that engage and substantially retain each other. Hook and loop fasteners include: a hook component having upstanding, hook type fastener elements; and a loop component having a surface of fibers or fiber loops capable of retaining the hook type fastener elements. Some hook type fastener elements have mushroom-like heads, while some are shaped like hooks defining crooks and extending in a particular direction. Hook-engageable loop components generally include knitted, woven, and non-woven textiles. A common example of a non-woven textile is a “spun bonded” textile made by spinning fine filaments of plastic resin (e.g. polypropylene) and distributing them in superimposed layers. The fibers are bonded to each other in random orientations with a fine, low-lying, nappy layer of looped and arched fibers exposed at the surface of the fabric.

### SUMMARY

In one aspect, a method of making a touch fastener includes continuously introducing molten resin to a pressure zone at a peripheral surface of a rotating mold roll, such that pressure in the pressure zone forces some of the resin into an array of stem cavities defined in the mold roll to form resin stems while a remainder of the resin forms a base at the roll surface, interconnecting the stems. The method includes forming engageable heads on the stems to form fastener elements and transferring an image substance onto the peripheral surface of a nip transfer roll that transfers the image substance into the pressure zone. The image substance becomes bonded to the resin of the base in the pressure zone to form an image visible on the base.

In some instances, the nip transfer roll is the mold roll. In other instances, the nip transfer roll is a counter-rotating pressure roll, the pressure zone defined between the mold roll and the pressure roll. The nip transfer roll carries the image substance directly into the nip

In some implementations, the method includes continuously introducing a flexible substrate to the pressure zone, such that the base of resin is permanently laminated to the substrate in the pressure zone.

The image substance can be a flowable composition when applied to the peripheral surface of the nip transfer roll. The flowable composition is transferred onto the molten resin. In some instances, the image substance is a high viscosity resin having a melt flow rate of about 0.45 grams/10 minutes. In other instances, the image substance is a low viscosity resin having a melt flow rate of about 35 grams/10 minutes.

The method may include transferring the image substance from an image transfer roll onto the peripheral surface of the nip transfer roll. The peripheral surface of the image transfer roll is sometimes engraved with a pattern corresponding to the image. In some examples, the cavities remain substantially free of the image substance.

In some implementations, the method includes, prior to transferring the image substance to the nip transfer roll, positioning a mask against the peripheral surface of the nip transfer roll, such that the mask resists transference of the image substance to selected regions of the peripheral surface of the nip transfer roll. The mask is removed from the nip transfer roll before the image substance enters the nip.

The peripheral surface of the nip transfer roll may be configured to temporarily retain the image substance on certain portions of the peripheral surface to form an image. For example, the certain portions of the peripheral surface of the nip transfer roll that temporarily retain the image substance are arranged in a pattern that is transferred to the resin base.

In another aspect, a touch fastener includes an elongated resin base having upper and lower surfaces, and a plurality of touch fastener elements extending from the lower surface. An array of seamless, spaced apart touch fastener elements extend from the upper surface of the base. At least one base surface carries an image substance arranged to define a visible image that varies across the fastener product. The image substance extends continuously between opposing lateral surfaces of at least several adjacent pairs of fastening elements.

In some implementations, the image substance is a flowable composition molded integral with the base. In other implementations, the image substance is a resin powder molded integral with the base.

The details of one or more implementations of the disclosure are set fourth in the accompanying drawings and the description below. Other features, objects, and advantages will be apparent from the description and drawings, and from the claims.

### DESCRIPTION OF DRAWINGS

FIG. 1 is a schematic view of a manufacturing process for forming touch fasteners including an image transfer roll.

FIG. 2 is a schematic view of a manufacturing process for forming touch fasteners including an image sprayer.

FIG. 3 is a schematic view of a manufacturing process for forming touch fasteners including continuously introducing a substrate to a forming nip.

FIG. 4 is a schematic view of a manufacturing process for forming touch fasteners including continuously introducing a substrate to a forming nip and transferring an image onto the substrate.

FIG. 5 is a schematic view of a pressure roll defining particle retention regions, as a portion of a manufacturing process for forming touch fasteners.

FIG. 6 is a side view, in partial cross-section, illustrating molten plastic extrusion into a forming nip between first and second co-acting forming rollers.

FIG. 7 is a side view of a touch fastener with an array of fastener elements and an image on a bottom base surface.

FIG. 8 is a top view of the touch fastener of FIG. 13.

FIG. 9 is a top perspective view of a touch fastener with an image visible on a base of the touch fastener.

FIG. 10 is a bottom perspective view of a touch fastener with an image visible on a base of the touch fastener.

FIG. 11 is a perspective view of a touch fastener with images visible on a base of the touch fastener.

Like reference symbols in the various drawings indicate like elements.

### DETAILED DESCRIPTION

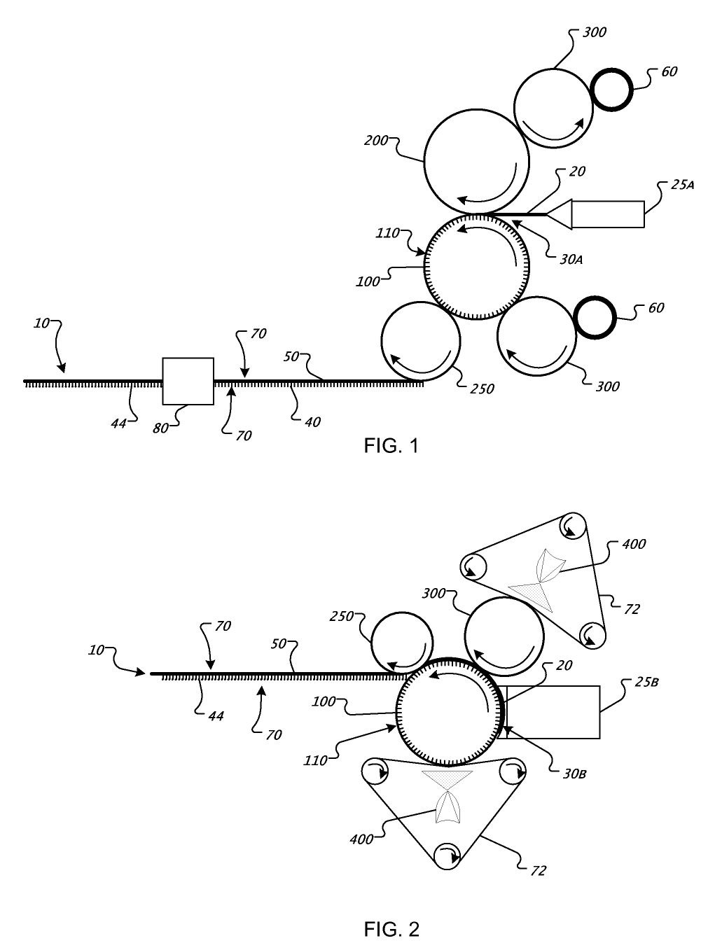

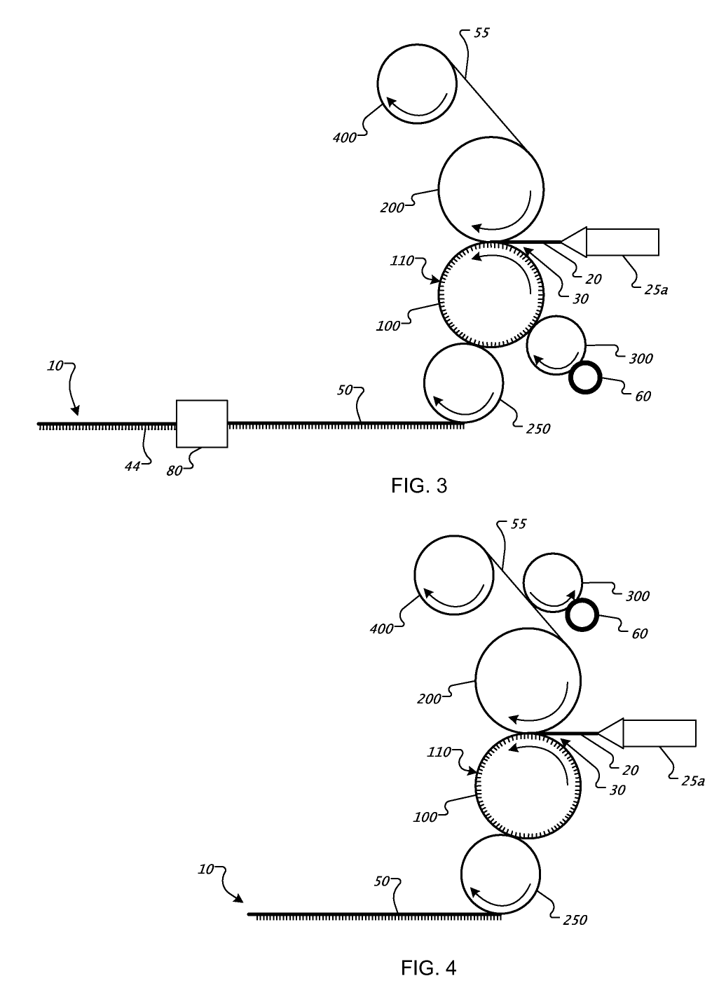

Referring to FIGS. 1-3, a method of making a touch fastener 10 includes continuously introducing molten resin 20 to a nip 30 formed adjacent a peripheral surface of a rotating mold roll 100. In some implementations, the method includes continuously introducing molten resin 20 (e.g. via an extruder 25a) to a nip 30a formed between a peripheral surface of a rotating mold roll 100 and a peripheral surface of a rotating pressure roll 200, as illustrated in FIGS. 1-2. In other implementations, the method includes continuously introducing molten resin 20 to the nip 30 from an extruder 25b to a nip 30b formed between a peripheral surface of a rotating mold roll 100 and a peripheral surface of the extruder 25b, as shown in FIG. 3. The process is similar to that described above, except only a mold roll 100 is used, i.e., no pressure roll 200 is necessary. Here, the extruder 25b is shaped to conform to the periphery of the mold roll 100 and the extruded resin 20 is introduced under pressure directly to the nip 30b formed between mold roll 100 and extruder 25b. The resin 20 at least partially fills an array of fastener cavities 110 defined in the rotating mold roll 100 to form resin stems 40 while a base 50 of resin 20 is formed interconnecting the stems 40. The molded fastener component 10 is stripped from the mold cavities 110 by a release roll 250. Further details regarding this process are described in U.S. Pat. Nos. 4,794,028, 5,781,969, and 5,913,482, the entire contents of which are hereby incorporated by reference.

The method includes transferring an image substance 60 arranged as an image 70 onto the peripheral surface of at least one of the mold roll 100 and the pressure roll 200. The roll 100, 200 then transfers the image substance 60 onto the molten resin 20 in the nip 30. In one example, the roll 100, 200 acts as a printing drum, printing the image substance 60 onto the molten resin 20 in the nip 30.

The resin 20 can be a thermoplastic or a thermoset. When the resin 20 is a thermoplastic, it can be, e.g., a polyolefin, such as a polyethylene (e.g., a copolymer of polyethylene), or a polypropylene (e.g., a copolymer of polypropylene); a polyester, such as polyethylene terephthalate (PET); a polyamide, such as nylon 6, 6/12 or 6/10; an elastomeric styrenic copolymer, such as a styrene-ethylene-butylene-styrene copolymer; a polyamide elastomers, such as polyether-polyamide copolymer; an ethylene-vinyl acetate copolymer; or mixtures of these resin.

To provide unique composites, it is often desirable to use a relatively viscous resin, which can enhance image visibility by preventing the image substance 60 from “slipping” beneath the external surface 51, 52 of the resin base 50 where it would be hidden from view.

In some implementations, the resin is a polyolefin, e.g., a polypropylene, having a melt flow rate of less than 50 grams/10 minutes, e.g., less than 25 grams/10 minutes, less than 20 grams/10 minutes, less than 17 g/10 minutes, less than 15 grams/10 minutes, less than 10 grams/10 minutes, less than 7.5 grams/10 minutes, less than 5 grams/10 minutes, less than 2.5 grams/10 minutes, or even less than 1 grams/10 minutes. For compression molding and extrusion, it can be desirable to that the melt flow rate be greater than 0.1 grams/10 minutes. Relatively low melt flow rates will generally provide relatively lower diffusion of the image substance 60 in the resin 20. Melt flow rates are measured using ASTM D1238 at 230° C. and 2.16 kg, the disclosure of which is hereby incorporated by reference herein in its entirety.

The image substance 60 may be in the form of a liquid (e.g. ink or other flowable composition) and/or a powder. Examples of the image substance 60 include polypropylene, high density polyethylene (HDPE), low density polyethylene (LDPE), Nylon, poly vinyl chloride (PVC), and blends of the aforementioned substances. The viscosity of the image substance 60 affects not only the quality of the image 70, but also flow characteristics of the molten resin 20. Consequently, in liquid form, the image substance 60 may have a viscosity similar to that of the resin. In some examples the image substance 60 has a viscosity of between about 175 P2Sec to about 1000 P₂Sec at a shear rate of between about 100 l/s to about 1000 l/sec. The composition of the image substance 60 is such that the image substance 60 does not readily mix with the resin 20, allowing the arranged image 70 to maintain its form in the nip 30 while bonding to the resin 20.

In the examples illustrated in FIGS. 2-3, the method includes applying the image substance 60 to a transfer roll 300, which applies the image substance 60 to the mold roll 100 and/or the pressure roll 200. The image substance 60 is rolled or sprayed onto the transfer roll 300, and can be applied by any other application method (e.g. dipped into a bath of image substance 60). In some examples, the peripheral surface of the transfer roll 300 is etched, stamped, or engraved with the image 70. In some instances, the image substance is a high viscosity resin having a melt flow rate of about 0.45 grams/10 minutes. In other instances, the image substance is a low viscosity resin having a melt flow rate of about 35 grams/10 minutes.

In some implementations, the method includes spraying the image substance 60 onto the mold roll 100 and/or pressure roll 200 with a sprayer 400, as shown in FIG. 3. A mask 72 (e.g. a sheet with an image cut-out or an image resistor substance) is positioned between the sprayer 400 and the roll 100, 200, inhibiting application of the image substance 60 onto non-image portions of the roll 100, 200 thus creating the image 70 to be transferred. In the example shown, the mask 72 is a rotating continuous sheet that provides a continuous image 70.

In implementations using a powder form of image substance 60, the peripheral surface of the roll 100, 200 receiving the image substance 60 is configured to temporarily retain the image substance 60 on certain portions to form the image 70. For example, the peripheral surface of the roll 100, 200 may include a tacky substance on certain portions to retain a powder.

Referring to FIGS. 3-4, in some examples the method further includes continuously introducing a flexible substrate 55 from a substrate roll 400 to the nip 30, such that the resin base 50 is laminated to the substrate 55 on the peripheral surface of the pressure roll 200. Heat and pressure in the nip 30 (also referred to as a gap) laminate and bond the substrate 55 to the thermoplastic resin 20 while simultaneously forming the fastener stems 40. The result can be a contiguous molded structure, without seams or weld lines, extending from the tips 42 of the fastener 10 into the substrate 55, where the resin can intimately bond with features or particles of the substrate 55 to form a strong, permanent bond. Further details regarding this process are described by Kennedy et al., U.S. Pat. No. 5,260,015, the disclosure of which is hereby incorporated in full by reference. In some implementations, the image substance 60 is continuously transferred onto the substrate 55 which carries the image substance 60 into the nip 30, as shown in FIG. 4, exposing the image substance 60 to the molten resin 20 during formation of the base 50. The substrate 55 may have a tacky or retentive quality that retains powder forms of image substance 60 on the surface of the substrate 55. Heat and pressure in the nip 30 secure the image substance 60 to the resin base 50. The resin 20 and/or the substrate 55 may be substantially transparent to accentuate a visual appearance of the image substance 60 and formed image 70.

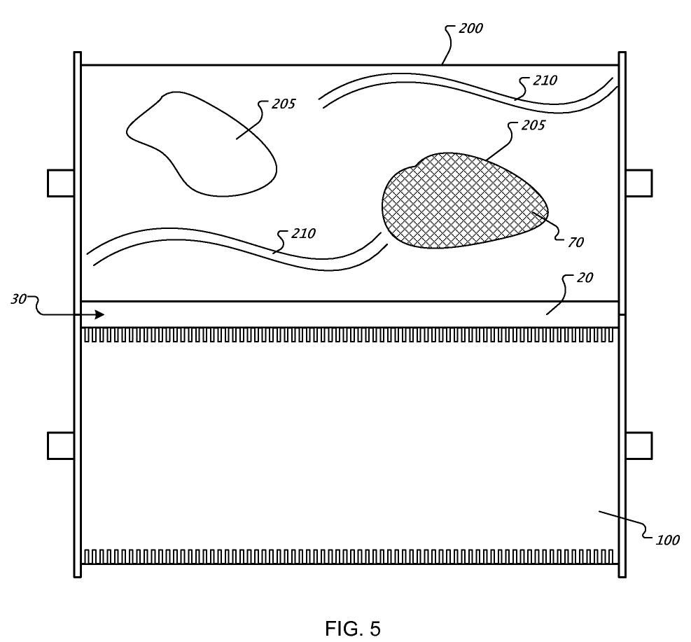

Referring to FIG. 5, in some implementations the image substance 60 is retained on discrete image retention regions 205 of the peripheral surface of the mold roll 100 and/or pressure roll 200. The retention regions 205 define a pattern corresponding to a desired image 70. Examples of image patterns include various arrangements of lines, checked patterns that simulate the appearance of a woven surface, pictures, logos or other graphics. The image substance 60 is retained on the peripheral surface of the mold roll 100 or pressure roll 200 in the retention regions by some retention means, such as electro-static adhesion, surface tension, or a tacky substance, for example. In the example of electro-static adhesion, a static charge is applied to the roll 100, 200 which then attracts and retains transferred image substance 60 on the peripheral surface of the roll 100, 200. When a liquid is applied to the roll 100, 200, surface tension of the liquid retains transferred image substance 60 on the peripheral surface of the roll 100, 200. In some examples, the peripheral surface of the mold roll 100 and/or pressure roll 200 defines undulations 210 configured to carry the deposited loose particles 60, such as powders. The undulations 210 may also be used to provide different surface characteristics of the base 50 (e.g. modified surface roughness, waviness, textured surface, embossing, etc).

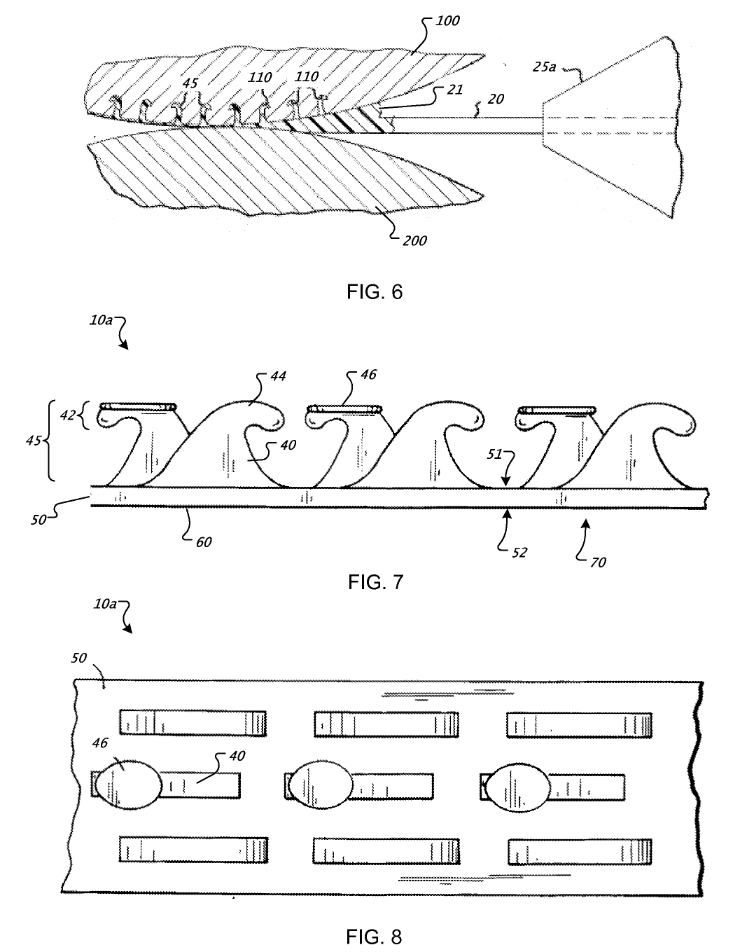

The method includes forming stems 40 on a base 50 of resin 20. The resin 20 at least partially fills the array of cavities 110 defined in the rotating mold roll 100 to form resin stems 40 while a base 50 of resin 20 is formed interconnecting the stems 40. The forming roller 100 and the pressure roller 200 are configured to permit relief of pressure at the laterally opposite sides of their interface so that the lateral flow of plastic material at the interface is unconfined. This arrangement has been found to provide added flexibility in practicing the present method since sufficient molten plastic material can be provided in the form of extrusion 20 to assure complete filling of the hook-forming cavities 110, while at the same time excessive pressure is not created at the interface which could otherwise act to urge the rollers 100 and 200 away from each other. As will be appreciated, appropriate selection of the linear forming speeds of the fastener member 10, as well as appropriate temperature control can avoid the need for providing pressure relief at the roller interface. In this regard, it will be observed in FIG. 6 that an enlarged “bank” designated 21 is formed just upstream of the interface of the forming roller 100 and the pressure roller 200. While it is desired that the bank 21 be of minimum dimension to avoid urging the rollers 100 and 200 apart, the creation of this bank assures the presence of an adequate supply of molten plastic material for complete filling of the hook-forming cavities 110. Image substance 60 applied to one of the forming rolls 100, 200 meets the bank 21 of resin 20 as the image substance 60 is carried into the nip 30, where the image substance 60 becomes integral with the formed base 50. Once transferred to the resin 20, the image substance 60 is unrestrained in movement and flow. Consequently, the image 70 arranged on the roll 100, 200 may stretch or slightly distort in one or more directions (e.g., longitudinal and/or transverse directions with respect to a feed direction).

Referring again to FIGS. 1-2, the method includes forming engageable heads 44 on the stem tips 42 with a tip forming device 80. In some examples, the tip forming device 80 includes a roller that flattens the stem tips 42 into engageable heads 44. Referring to FIGS. 2 and 6, in other examples, the entire fastener elements 45, including engageable heads 44 on the tips 42 of the stems 40, are formed while in the nip 30. The cavities 110 defined by the mold roll 100 are shaped to form stems 40 with engageable heads 44 on the tips 42 of stems 40. Each hook projection 45 is provided with a configuration wherein the free end portion 42 of each projection 45 extends generally radially away from and generally toward the base portion 50 of the fastener 10. It should further be noted that adjacent hook projections 45 face in generally opposite directions in a direction along the length of the fastener 10. These features of the construction promote the desired interaction with the associated multi-loop fastener element, and assure the desired gripping or fastening action between the multi-hook fastener member and the multi-loop element. The engageable heads 44 flex or rotate about the stem during release from the mold roll 100.

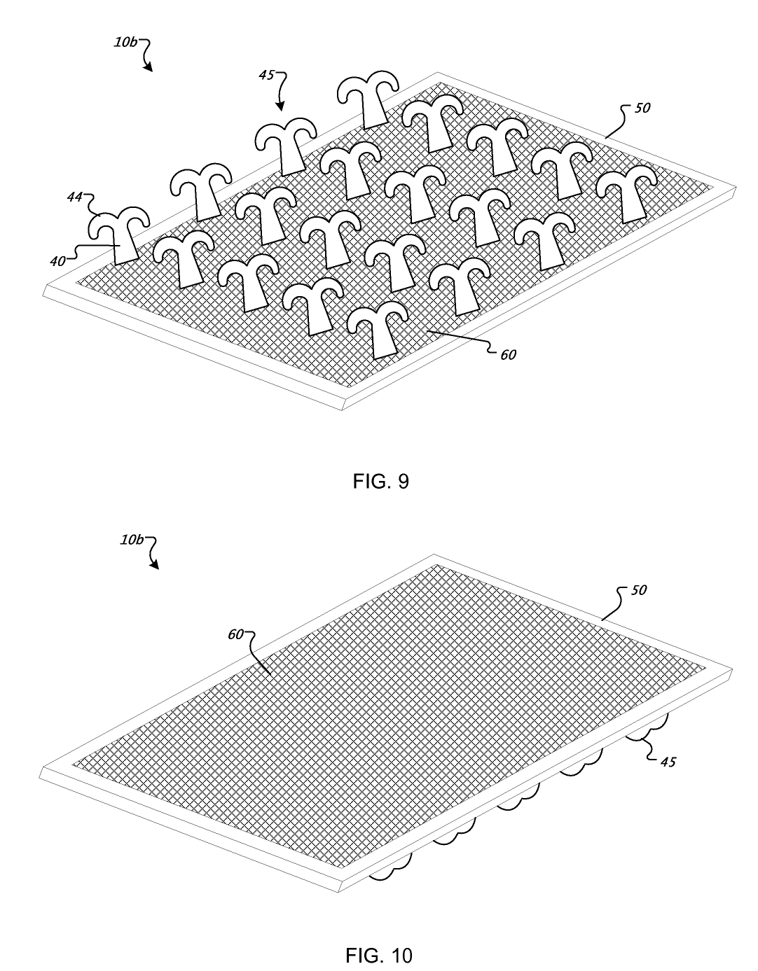

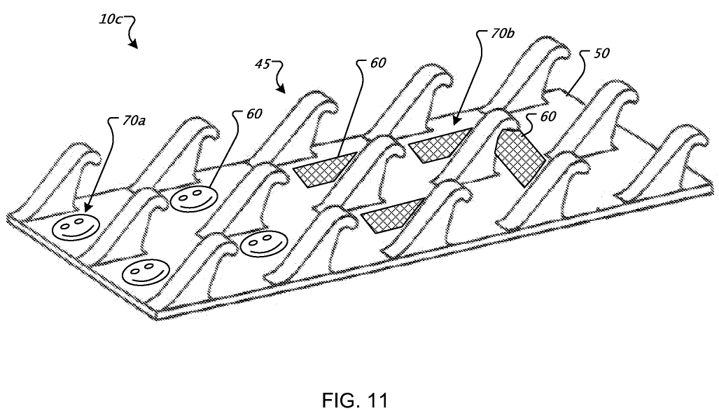

In the examples illustrated in FIGS. 6-11, engageable heads 44 of the touch fastener 10 are deformed (e.g. flattened) by a tip forming device 80 to form flat portion 46 on the engageable head 44. A touch fastener 10a, 10b, 10c (e.g. as resulting from the methods of manufacture described herein) includes an elongated resin base 50 having upper and lower surfaces 51 and 52, respectively, and a plurality or array of touch fastener elements 45 extending from the upper surface 51. An image 70 comprised of image substance 60 is visible on the upper and/or lower surfaces 51 and 52, respectively, of the base 50. The image may provide a cloth-like appearance to the fastener 10. In the example illustrated in FIG. 11, the touch fastener 10c includes multiple images 70a, 70b visible on the base 50. The base 50 may include graphical illustrations 70a (e.g. faces, designs, art work, etc) and/or images 70b that provide an appearance of a particular surface finish, for example, a cloth-like appearance.

A number of implementations have been described. Nevertheless, it will be understood that various modifications may be made without departing from the spirit and scope of the disclosure. Accordingly, other implementations are within the scope of the following claims.

What is claimed is:

1. A method of making a touch fastener, the method comprising:
continuously introducing molten resin to a pressure zone at a peripheral surface of a rotating mold roll, such that pressure in the pressure zone forces some of the resin into an array of stem cavities defined in the mold roll to form resin stems while a remainder of the resin forms a base at the roll surface, interconnecting the stems;
forming engageable heads on the stems to form fastener elements; and
transferring an image substance onto the peripheral surface of a nip transfer roll that transfers the image substance into the pressure zone;
wherein the image substance becomes bonded to the resin of the base in the pressure zone to form an image visible on the base.

2. The method of claim 1, wherein the nip transfer roll is the mold roll

3. The method of claim 1, wherein the nip transfer roll carries the image substance directly into the pressure zone.

4. The method of claim 1, wherein the nip transfer roll comprises a counter-rotating pressure roll, the pressure zone formed between the mold roll and pressure roll.

5. The method of claim 1 further comprising continuously introducing a flexible substrate to the pressure zone, such that the base of resin is permanently laminated to the substrate in the pressure zone.

6. The method of claim 1, wherein the image substance comprises a flowable composition when applied to the peripheral surface of the nip transfer roll, the flowable composition being transferred onto the molten resin.

7. The method of claim 1, wherein the image substance comprises a resin powder having a melt flow rate of about 0.45 grams/10 minutes.

8. The method of claim 1, wherein the image substance comprises a resin powder having a melt flow rate of about 35 grams/10 minutes.

9. The method of claim 1 further comprising transferring the image substance from an image transfer roll onto the peripheral surface of the nip transfer roll.

10. The method of claim 9, wherein the peripheral surface of the image transfer roll is engraved with a pattern corresponding to the image.

11. The method of claim 1, wherein the cavities remain substantially free of the image substance.

12. The method of claim 1 further comprising, prior to transferring the image substance to the nip transfer roll, positioning a mask against the peripheral surface of the nip transfer roll, such that the mask resists transference of the image substance to selected regions of the peripheral surface of the nip transfer roll.

13. The method of claim 12 further comprising removing the mask from the nip transfer roll before the image substance enters the nip.

14. The method of claim 1, wherein the peripheral surface of the nip transfer roll is configured to temporarily retain the image substance on certain portions of the peripheral surface to form an image.

15. A touch fastener comprising:
an elongated resin base having upper and lower surfaces; and a plurality of touch fastener elements extending from the lower surface; and
an array of seamless, spaced apart touch fastener elements extending from the upper surface of the base;
wherein at least one base surface carries an image substance arranged to define a visible image that varies across the fastener product, the image substance extending continuously between opposing lateral surfaces of at least several adjacent pairs of fastening elements.

16. The touch fastener of claim 15, wherein the image substance comprises a flowable composition molded integral with the base.

17. The touch fastener of claim 15, wherein the image substance comprises a resin powder molded integral with the base.
